(19) United States
(12) Patent Application Publication
(10) Pub. No.: US 2014/0284513 A1
(43) Pub. Date: Sep. 25, 2014

(54) Oil Reclamation Mixture

(71) Applicant: Robert Beadles, Lodi, CA (US)

(72) Inventor: Robert Beadles, Lodi, CA (US)

(73) Assignee: Mr. Robert Beadles, Lodi, CA (US)

(21) Appl. No.: 13/849,863

(22) Filed: Mar. 25, 2013

(51) Int. Cl. C09K 3/32

(52) U.S. Cl. CPC C09K 3/32
USPC 252/60

(57) ABSTRACT

An oil reclamation mixture consisting of an activating compound, mechanical coagulant and co-factors. Oil spills and their resultant contamination of life is an ongoing threat that affects the entire bio-ecosystem (marine and terrestrial, alike) and to financial markets. By using a mixture of natural ingredients and chemical principles, the threats to ecosystems are mitigated. Traditionally Oil Dispersants have been used to spread out the contamination, however, in our mixture utilizes non-toxic off the shelf ingredients to provide a product that induces free oil floating on the surface of water to coagulate and form aggregate clumps for easy of skimming off the surface in a clean up operation. Because less toxic materials are used, inhabitants and marine life of the affected area are less impacted financially and physically. The oil can also be reclaimed and recycled out of the recovered materials that are skimmed. Because no toxic materials are used to lock up and coagulate the oil material, this process is seen as new and unique.

### CROSS-REFERENCE TO RELATED APPLICATIONS

Not Applicable

### STATEMENT REGARDING FEDERAL SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

This SPEC is a replacement SPEC, and contains no new matter.

Oil reclamation is big business, recently with the BP spill. We have developed this product with that in mind, making this process less toxic and more cost effective and with less of an impact on the environment and its marine or terrestrial inhabitants. It works quickly to isolate spilled organic materials so they can be skimmed out of the environment and processed to reclaim the spilt or lost product. We have developed an Oil Reclamation Mixture that is new and unique using all natural organic material that decomposes and is therefore a more environmentally friendly and “green” option for oil spills.

Current U.S. Classification: 502/402; 210/502.1; 210/922; 210/924; 252/60; 405/62; 405/63; 52 1/79; 525/148; 525/163

### BRIEF SUMMARY OF THE INVENTION

This invention relates to an Oil Reclamation Mixture and a method of cleaning mistakenly spilt oil from transport, off-shore drilling and/or land-based drilling.

Oil reclamation is big business, recently with the BP spill. We have developed this product with that in mind, while making this process less toxic, more cost effective and with less of an impact on the environment and its marine or terrestrial inhabitants. It works quickly to isolate spilled organic materials so they can be skimmed out of the environment and processed to reclaim the spilt or lost product.

A) Traditionally large quantities of oil dispersant have been used at Exxon Valdeez or BP's disaster in the Gulf Coast. This technology offered is not a dispersant per se, but a aggregator or coagulant that still allows the material to float so that it can be skimmed off the top of the water and isolated. By isolating and extracting the spillage material, it can be removed as a threat to wildlife, the ecosystem and or terrestrial inhabitants that will encounter it at water's edge, or in their drinking water.

B) It is well known in the prior art to provide a material that can break up oil at a spill using a detergent. What we are providing is something different, it helps is the solidification and aggregation of the oil that is spilled so its removal can be executed.

### BRIEF DESCRIPTION OF THE DRAWINGS

Not Applicable

### DETAILED DESCRIPTION AND BEST MODE OF IMPLEMENTATION

### References (Incorporated Herein by Reference)

Please find references below.

| | | Publication | | |
|---|---|---|---|---|
| Cited Patent | Fng date | date | Applicant | Title |
| DE2208748A1 | | | | Title not available |
| U53265616 | Dec. 20, 1963 | Aug. 9, 1966 | The International | Method of cleaning |
| | | | Synthetic Rubber | or collecting oil from |
| | | | Company Limited | the surface of an |
| | | | | area of water |
| W01992007917A1 | Oct. 29, 1991 | May 14, 1992 | Kalocsai, Guy, | Reversible |
| | | | Imre, Zoltan | transformation of |
| | | | | hydrocarbons |
| U53111500 | Jan. 27, 1959 | Nov. 19, 1963 | | PROCESS |
| | | | | COMPRISING |
| | | | | HEATING A |
| | | | | MIXTURE |
| U53862963 | Apr. 23, 1973 | Jan. 2, 1975 | | ADSORBENT |
| | | | | FOR OILS |
| U53960722 | Jan. 27, 1975 | Jun. 1, 1976 | Idemitsu, Kosan | Oil adsorbent |
| | | | Kabushiki Kaisha | |
| | | | (Idemitsu Kosan | |
| | | | Co., Ltd.) | |
| U.S. Pat. No. 4,135,943 | Apr. 5, 1976 | Jan. 23, 1979 | Toyo Jozo | Novel selective |
| | | | Company, Ltd. | adsorbents |
| U.S. Pat. No. 4,206,080 | Feb. 2, 1978 | Jun. 3, 1980 | Mitsubishi Rayon | Method of |
| | | | Company, | producing of |
| | | | Limited | treating material |
| | | | | for oil-containing |
| | | | | waste water |
| U.S. Pat. No. 4,446,254 | Apr. 9, 1982 | May 1, 1984 | The Furukawa | Crosslinked |
| | | | Electric Co., Ltd. | polyolefin foam |
| | | | | containing a high |
| | | | | concentration of an |
| | | | | inorganic material |
| | | | | and process for |
| | | | | producing the |
| | | | | same |
| U.S. Pat. No. 4,871,811 | Aug. 23, 1988 | Oct. 3, 1989 | Mitsubishi Gas | Hot melt adhesive |
| | | | Chemical | composition |
| | | | Company, Inc. | |
| U.S. Pat. No. 4,931,484 | Jun. 14, 1989 | Jun. 15, 1990 | Applied | Extruded ethylenic |
| | | | Extrusion | polymer foam |
| | | | Technologies, | containing both |
| | | | Inc. | open and closed |
| | | | | cells |
| U.S. Pat. No. 5,120,598 | Aug. 2, 1991 | Jun. 9, 1992 | Air Products and | Fibrous material |
| | | | Chemicals, Inc. | for oil spill clean- |
| | | | | up |
| U.S. Pat. No. 5,432,000 | Mar. 22, 1991 | Jul. 11, 1995 | Weyerhaeuser | Binder coated |
| | | | Company | discontinuous fibers |
| | | | | with adhered |
| | | | | particulate |
| | | | | materials |
| U.S. Pat. No. 6,264,398 | Dec. 9, 1999 | Jul. 24, 2001 | Yugenkaisha | Process for the |
| | | | Fams Japan as | recovery of oil |
| | | | represented by | |
| | | | Director General of | |
| | | | IndustrialScience | |
| | | | and Technology | |
| U.S. Pat. No. 3,464,920 | Jul. 20, 1967 | 19 [symbol] | | METHOD OF |
| | | | | REMOVING OIL |
| | | | | FROM THE SUR- |
| | | | | FACE OF WATER |
| | | | | USING |
| | | | | OLEOPHILIC, |
| | | | | HYDRO- PHOBIC |
| | | | | COMMINUTED |
| | | | | ORGANIC |
| | | | | MATERIALS |
| U53739913 | Jul. 6, 1970 | 19 [symbol] | | DEVICE FOR |
| | | | | FENCING AND |
| | | | | ABSORBING |
| | | | | CONTAMINATING |
| | | | | OIL SPILLS ON |
| | | | | WATER |
| U53770575 | May 26, [symbol] | 19 [symbol] | | METHOD OF |
| | | | | MAKING A |
| | | | | HYDROPHOBIC |
| U.S. Pat. No. 3,812,973 | Mar. 22, 1972 | 1974 | | COMPOSITION |
| | | | | OF MATTER FOR |
| | | | | CONTROLLING |
| | | | | OIL POLLUTION |
| | | | | AND |
| | | | | PREFERABLY OIL |
| | | | | DISCHARGE IN |
| | | | | WATER |
| U53888766 | Mar. 9, 1973 | 1975 | | OIL SORPTION |
| | | | | MATERIAL |
| U53976570 | Apr. 18, 1975 | Aug. 24, 1976 | | Method and |
| | | | | apparatus for |
| | | | | removing |
| | | | | contaminants from |
| | | | | the surface of a |
| | | | | body of water |
| U54102783 | Dec. 8, 1976 | Jul. 25, 1978 | Daicel Ltd. | Adsorbent process |
| | | | | for oily materials |
| U.S. Pat. No. 4,172,031 | Nov. 4, 1975 | Oct. 23, 1979 | The Dow | Separation of oil |
| | | | Chemical | from water |
| | | | Company | |
| U54537877 | May 10, 1983 | Aug. 27, 1985 | Papyrus | Particulate oil- |
| | | | Kopparfors AB | absorbing |
| | | | | composition to |
| | | | | absorb oil |
| U54692059 | Feb. 6, 1986 | Sep. 8, 1987 | Tamfelt Oy Ab | Method of and a |
| | | | | means for |
| | | | | protecting |
| | | | | shores against |
| | | | | oil pollutants |
| U54784773 | Jul. 27, 1987 | Nov. 15, 1988 | | Petroleum product |
| | | | | absorbtion method |
| | | | | and apparatus |
| W02011046445A1 | Oct. 12, 2010 | Apr. 21, 2011 | Hoegoey, | Organic oil boom |
| | | | Ingmar | |
| W02012008841A1 | Jul. 14, 2010 | Jan. 19, 2012 | Ellingsen, | Natural -origin |
| | | | Hans | enzymatic bioremediation with |
| | | | Falnes | wide applicability, the substrate |
| | | | | being an environment consisting |
| | | | | of extracts from oleaginous |
| | | | | vegetable sources added to an |
| | | | | isomer mixture |
| U.S. Pat. No. 5,110,785 | May 1, 1991 | May 5, 1992 | | Composition of matter |
| | | | | and method of making |
| U.S. Pat. No. 5,181,802 | Apr. 26, 1991 | Jan. 26, 1993 | | Oil collector |
| U.S. Pat. No. 5,192,455 | Aug. 26, 1991 | Mar. 9, 1993 | | Pollution pad |
| | | | | reconditioning/recycling |
| | | | | system |
| U.S. Pat. No. 5,252,215 | Apr. 21, 1992 | Oct. 12, 1993 | Wool Research | Adsorbent materials |
| | | | Organisation of New | and use thereof |
| | | | Zeland, Inc. | |
| U.S. Pat. No. 5,395,535 | Sep. 12, 1994 | Mar. 7, 1995 | | Removal of hazardous |
| | | | | chemical substances |
| | | | | floating on water |
| U55429741 | Jan. 14, 1994 | Jul. 4, 1995 | Ecosorb International, | Sludge conditioning |
| | | | Inc. | |
| U55614458 | Jun. 30, 1995 | Mar. 25, 1997 | Ecosorb International, | Method for sludge |
| | | | Inc. | conditioning |
| U55780290 | Jun. 5, 1995 | Jul. 14, 1998 | Ramot, University of | Non-polluting |
| | | | Authority for Applied | compositions to |
| | | | Research and [symbol] | degrade hydrocarbons |
| | | | Development | and microorganisms for |
| | | | | use thereof |
| U55945026 | Apr. 2, 1997 | Aug. 31, 1999 | Hazard Control | Composition and |
| | | | Technologies, Inc. | methods for firefighting |
| | | | | hydrocarbon fires |
| U.S. Pat. No. 5,958,182 | Apr. 4, 1997 | Sep. 28, 1999 | FyBx Corporation | Process for converting |
| | | | | tropical plant material |
| | | | | into fibers |
| U.S. Pat. No. 6,027,652 | Apr. 4, 1997 | Feb. 22, 2000 | FyBx | Process for sorbing |
| | | | Environmental, | liquids using tropical |
| | | | Inc. | fibers |
| U.S. Pat. No. 6,139,775 | Jul. 30, 1999 | Oct. 31, [symbol] | Hazard Control | Compositions and |
| | | | Technologies, Inc. | methods for treating |
| | | | | hydrocarbon materials |
| U.S. Pat. No. 6,153,017 | Jan. 28, [symbol] | Nov. 28, [symbol] | Petrozyme | Treatment of soil |
| | | | Technologies Inc. | contaminated with oil or |
| | | | | oil residues |
| U.S. Pat. No. 6,187,581 | Jun. 24, [symbol] | Feb. 13, [symbol] | Unotec Services | Process and |
| | | | International Inc. | composition for treating |
| | | | | hydrocarbon |
| | | | | contaminated material |
| U.S. Pat. No. 6,251,058 | Jan. 28, 1999 | Jun. 26, 2001 | Petrozyme | Treatment of soil |
| | | | Technologies, Inc. | contaminated with |
| | | | | hazardous residues |
| U56326070 | Mar. 3, 1999 | Dec. 4, 2001 | Virkensdamm AB | Absorption means |
| U.S. Pat. No. 6,506,307 | Sep. 3, 1999 | Jan. 14, 2003 | Fybx Enviromental, Inc. | Process for sorbing |
| | | | | fibers |
| U.S. Pat. No. 6,881,345 | Oct. 14, 2002 | Apr. 19, 2005 | | Disposable fluid |
| | | | | changing kit and |
| | | | | method of disposing of |
| | | | | the same |
| U57544635 | Jul. 17, 2001 | Jun. 9, 2009 | | Process for changing |
| | | | | hydrophilic/hydrophobic |
| | | | | characteristics |
| U58024890 | Mar. 29, 2010 | Sep. 27, 2011 | OMS Investments, Inc. | Compressed coconut coir |
| | | | | pith granules and |
| | | | | methods for the |
| | | | | production and use |
| | | | | thereof |

[symbol]

indicates data missing or illegible when filed

### REFERENCE

DATABASE WPI Section Ch, Week 197526 Derwent Publications Ltd., London, GB;
1 Class Al2, AN 1975-43660W XP002153868 & JP 50 015006 B (NO H), 2 Jun. 1975 (1975-06-02)
DATABASE WPI Section Ch, Week 197845 Derwent Publications Ltd., London, GB;
2 Class A97, AN 1978-81012A XP002153869 & JP 53 113283 A (AGENCY OF IND SC1 & TECHNOLOGY), 3 Oct. 1978 (1978-10-03)
3 See also references of WO 9846530A1

I Claim:

1. A biodegradable organic oil reclamation composition consisting of:
a) non-toxic composition for spreading onto the oil-contaminated ariace
b) wherein the contaminated surface is over water, either salt or fresh, or lands.

2. The biodegradable organic oil reclamation composition of claim 1, wherein the composition is made up of natural materials and a proprietary non-toxic chemical admixture modifiers.

3. The composition of claim 2, wherein the composition, when used together, have the correct chemistry to dean up an oil spill.

4. The coagulated mixture of claim 1, wherein once the oil is trapped and bound up, can then be reclaimed and processed to recover at least a portion of the spilled oil content.

5. The coagulated mixture of claims 2 and 3, wherein the coagulated mixture is readily removed by skimming in water or sweeping while on and.

6. The coagulated mixture of claim 5, wherein the coagulated mixture is further processed to remove at least a portion of the oil content.
